(19) United States
(12) Patent Application Publication
(10) Pub. No.: US 2022/0380677 A1
(43) Pub. Date: Dec. 1, 2022

(54) SURFACE ACTIVATED NANOHYBRID FLAME RETARDANTS AND POLYMERS PRODUCED THEREFROM

(71) Applicant: P & S Global Holdings, LLC, Houston, TX (US)

(72) Inventors: Parash KALITA, Houston, TX (US); Wenping JIANG, Houston, TX (US)

(73) Assignee: P & S Global Holdings, LLC, Houston, TX (US)

(21) Appl. No.: 17/773,816

(22) PCT Filed: May 14, 2021
(86) PCT No.: PCT/US2021/032491

§ 371 Date: May 2, 2022

Related U.S. Application Data
(60) Provisional application No. 63/071,707, filed on Aug. 28, 2020.

(51) Int. Cl. C09K 21/04; C08K 3/08; C08K 3/32; C08K 3/36; C09D 5/18; C09D 5/14; C09D 123/12; A01N 59/20; A01N 59/16; A01P 1/00; A01N 25/10

(52) U.S. Cl. CPC C09K 21/04; C08K 3/08; C08K 3/32; C08K 3/36; C09D 5/18; C09D 5/14; C09D 123/12; A01N 59/20; A01N 59/16; A01P 1/00; A01N 25/10; C08K 2201/014; C08K 2201/011; C08K 2003/323; C08K 2003/085; C08K 2003/0806

(57) ABSTRACT

This invention relates to nanohybrid compositions derived from surface activation of halogenated and/or non-halogenated flame retardant (FR) materials with nanostructured copper and/or its oxides. The present disclosure also relates to polymer compositions manufactured by incorporating and reinforcing polymers/copolymers with nanohybrid compositions as flame retardant additives for enhanced fire resistance, smoke suppression, and antimicrobial capabilities. In one or more embodiments, the polymers and article of manufacture to which the particles are applied may have on or more of the following attributes: temperature adaptable flame retardant behavior, Enhanced suppression of flammable gas and smoke, catalysis of charring or thermal oxidative promotion of charring through the oxides of metals, enhanced heat sink behavior, and/or antimicrobial behavior.

### CROSS REFERENCE TO RELATED APPLICATIONS

This application claims priority to U.S. Provisional Application No. 63/071,707 filed on Aug. 28, 2020.

### STATEMENT REGARDING FEDERALLY SPONSORED RESEARCH OR DEVELOPMENT

Not Applicable.

### FIELD OF USE

This application relates to the creation and application of flame-resistant chemicals and additives. More specifically, this application relates to nanohybrid compositions derived from surface activation of halogenated and/or non-halogenated flame retardant (FR) materials with nanostructured copper and/or its oxides. It also relates to polymer compositions manufactured by incorporating and reinforcing polymers/copolymers with nanohybrid compositions as flame retardant additives for enhanced fire resistance, smoke suppression, and antimicrobial capabilities.

### REFERENCE TO A “SEQUENCE LISTING,” A TABLE, OR A COMPUTER PROGRAM

Table 1 presents antimicrobial test results of sealant foams composed of polyurethane-Cu—SiO2 based nanohybrid.

Table 2 presents antimicrobial performance testing of nanohybrid integrated polyamide.

### DESCRIPTION OF THE DRAWINGS

FIG. 1 is a graphical representation of nanohybrid flame retardant structures (and their preparation methods), in which at least one of the phases has at least one dimension less than 100 nm in size.

FIG. 2 is a graphical representation showing the process for forming polymers with nanohybrid flame retardants

FIG. 3 presents thermophysical properties of nanohybrid flame retardant integrated/reinforced polymers.

FIG. 4 shows TEM images of Cu-APP/SiO₂ nanohybrid structures showing deposition of Copper nanoparticles (15-20 nm) on APP-SiO₂ particles.

FIG. 5 shows vertical flammability (left) and antibacterial (right) assessment of nanohybrid-PU flame retardant coating.

FIG. 6 is a comparative graph showing the analysis of PP and nanohybrid-filled PP using thermogravimetric analysis (TGA).

### BACKGROUND OF THE INVENTION

To achieve proper level of fire resistance, polymers must be modified through the use of flame retardant additives/chemicals, which function by inhibiting or suppressing the combustion process. More than 175 chemicals belonging to inorganic, organohalogens, nitrogen-based, and organophosphorus type exist as known flame-retardants. There has been a raging debate for the last 2-3 decades on the sustainability of these chemicals as many have been recognized as global pollutants having adverse effects on human health and the ecosystem, especially organohalogens containing chlorine, bromine, fluorine, and iodine. Non-halogen flame retardants address environmental sustainability but need high quantity of addition in polymers to achieve satisfactory fire resistance as compared to organohalogens. Such high additions negatively impact the mechanical properties of polymers.

The present invention put forth a nanohybrid composition to bring a right balance of performance, sustainability and industrial applicability when used as a flame retardant additive in polymeric compositions. The inventive technology transforms off-the-shelf organic and inorganic flame retardants to unique nanohybrid compositions by modifying and activating them with nanostructured metallic copper and/or its oxides having high surface area to volume ratio, thermal conductivity, and antimicrobial properties. Ability for high heat fluxes as well as localized heating (heat flux concentration) as a function number density and distribution of thermally conductive nanoparticles in a matrix of flame retardants allow nanohybrid compositions to strengthen flame/fire resistivity of polymers even at low concentrations. Another ability of nanohybrid flame retardants is effective suppression of flammable gases and smoke formed during combustion, which are major causes of fire-related deaths as per NFPA.

Development of multi-function polymers with fire retardant efficacy and antimicrobial properties is necessary. Traditionally, halide or phosphorous is used as additives to improve the fire-retardant performance of polymers; metallic salts or particles are used as additives to impart antimicrobial properties. However, using the aforesaid additives create environmental issues, in addition to altering the mechanical properties of the polymers. To address these issues, US Patent application US 2006/0202177 A1 (the disclosure is incorporated herein by reference) proposes a mixture of copper nanoparticles and clay as a fire-retardant agent specifically for polyester or plastics. In the mixture, copper ions are mingled with clay, and are reduced by reducing agents to form copper nanoparticles in the clay. The mixture is expected to impart improved fire-retardancy of plastics while much less quantity of the fire-retardant agents is needed. However, this clay mixture could not provide temperature adaptable flame-retardant behavior as claimed for the current invention.

The nanohybrid compositions combine synergistic effects of temperature and flame-retardant reactions for enhanced flame retardancy activity and performance. In addition, due to inherent antimicrobial property of copper and its oxides against a wide range of bacteria, fungi, and viruses, the nanohybrid compositions have the capability to provide synergistic flame retardant and antimicrobial characteristics. The antimicrobial properties of copper-based nanoparticles are well known to those skilled in the art and are described in Brandelli et al, which is incorporated herein as reference.

Over-coated flame-retardant particles have also proposed (for example, in US 2006/0293415 A1 and US2007/0173563A1, the disclosures are incorporated herein by reference) to reduce the effect of excessive quantity of fire-retardant agents on the physical properties of resins. The overcoated flame-retardant particles consist of flame-retardant grain (as core), and an organic compound or a polysilicone as a continuous and uniform overcoated layer on the grain. The grain, with particle size of 1500 nm, comprises of a metal hydrate (Mg, Ca, Al, Fe, Zn, Ba, Cu, and Ni). The overcoated flame-retardant grains or particles are then used as additive to the resin to form fire-retardant composition. Nevertheless, the proposed process for producing overcoated particles or “core-shell” structure is complicated and difficult to control the thickness from particle to particle. Moreover, this structure is significantly different from the inventive nanohybrid where the core consists of organic/inorganic halogenated and/or non-halogenated flame retardant materials that are surface modified with nanoparticles of copper and/or its oxides with consistent size and shape. In the ‘over-coated flame-retardant particles’, the metallic compounds (including copper-based) are in the core and not on the surface like the inventive nanohybrid to directly influence temperature-activated flame retardant mechanisms as discussed above. As a result, over-coated flame-retardant particles cannot deliver (and will in fact inhibit) temperature adaptive flame retardant behavior and as well as synergistic antimicrobial characteristics.

Further, a structure of layer dihydroxy (LDH) metal oxide nanoparticles and methods for producing the nanoparticles using metal salt including silver nitrate, silver chlorate, copper chloride, copper nitrate, and copper sulphate is proposed (for example, in CN110330678A, the disclosure of which is included herein by reference). The nanoparticles are used as additive to polycaprolactone (CPL) film featuring antimicrobial and fire-retardant properties. However, the CPL membrane or film does not provide temperature adaptable flame-retardant behavior, while the LDH may help to reduce particle agglomeration during dispersion process.

A method preparing a core-shell nanostructure with core consisting of silica and shell of copper and silica with copper uniformly loaded in the copper and silica shell for biocidal applications is proposed (for example in US2013/0108702A1, the disclosure of which is incorporated by reference). The resulted copper nanostructures do offer biocidal/antimicrobial efficacy. However, it does have not provide the synergistic flame retardant characteristics as neither of the constituents—Copper and/or silica has inherent flame retardant properties. The current invention provides a unique solution to these deficiencies by hybridizing the nanostructured copper and its oxides with organic and inorganic flame retardant materials to yield synergistic antimicrobial and flame retardant properties when integrated in polymers.

### SUMMARY

This invention relates to nanohybrid compositions derived from surface activation of halogenated and/or non-halogenated flame retardant (FR) materials with nanostructured copper and/or its oxides. The present disclosure also relates to polymer compositions manufactured by incorporating and reinforcing polymers/copolymers with nanohybrid compositions as flame retardant additives for enhanced fire resistance, smoke suppression, and antimicrobial capabilities. In one or more embodiments, the polymers and article of manufacture to which the particles are applied may have one or more of the following attributes: temperature adaptable flame retardant behavior, enhanced suppression of flammable gas and smoke, catalysis of charring or thermal oxidative promotion of charring through the oxides of metals, enhanced heat sink behavior, and/or antimicrobial behavior.

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Furthermore, the described features, structures, or characteristics may be combined in any suitable manner in one or more embodiments. In the following description, numerous specific details are provided, such as examples of particle size, compounds, and processes or reactions for the formation thereof. One skilled in the relevant art will recognize, however, that the disclosed surface activated nanohybrid flame retardants may be practiced without one or more of the specific details, or with other methods, components, materials, and so forth.

The instant invention relates to nanohybrid flame retardant compositions which may be developed by modifying and activating the surface of halogenated and non-halogenated flame-retardant materials (generally, between 10-10000 nm in size) with nanostructured metallic copper and/or copper oxide (generally, 1-100 nm in size). For the purposes of this disclosure, grafting, embedding and/or depositing nanostructured copper and/or its oxides on flame retardants (matrix material) will be characterized as modification and activation from here onwards unless otherwise noted. In one embodiment, the percentage composition of Copper and/or Copper Oxide (in the form of Cu₂O and/or CuO) nanoparticles are from 10 weight parts per million (wppm) to 100000 wppm and halogenated and/or non-halogenated flame retardants are from 50 wt. % to 99.999 wt. %, where flame retardant material species can be selected from nano-halogenated flame retardants, halogenated flame retardants, and/or organophosphorus flame retardants.

Known non-halogenated flame retardants include but are not limited to: Ammonium polyphosphate, Aluminum trihydroxide, Magnesium (di) hydroxide, Melamine polyphosphate, Zinc molybdate, Calcium zinc molybdate, Zinc oxide/phosphate complexes, zinc carbonates, zinc borates, antimony trioxides, tin oxides, iron oxides, zeolites, Glass fibers, Melamine, Melamine Cyanurate, Melamine homologues, Carbon-based materials (graphite/expandable graphite, graphene/graphene oxide, carbon nanotubes (CNTs) etc.) and inorganic materials, like Gypsum, Calcium Carbonate, Silicon Dioxide, Silicon Carbide, and Aluminum silicates (clays, HNTs, etc.). Halogenated flame retardants may include any organo-halogen flame retardants that contains chlorine or bromine, or iodine or fluorine bonded to carbon. Organophosphorus flame retardants (OPFRs) including organophosphates, organophosphonates, organophosphintes, organophosphine oxides, and organophosphites.

In one or more embodiments, the nanohybrid flame retardants can consist of other species of metallic nanoparticles. These may include zinc, silver, gold, aluminum, antimony, molybdenum, iron and their compounds, and they may either completely replace or be used in combination with copper and its oxides. Additionally, the nanohybrid flame retardants may be synthesized via either chemical reduction and/or high-energy mechanical alloying. The particular process, or combination thereof, may be selected depending on the desired chemical combination and size ratio of Cu/Cu₂O/CuO nanoparticles and flame retardant materials.

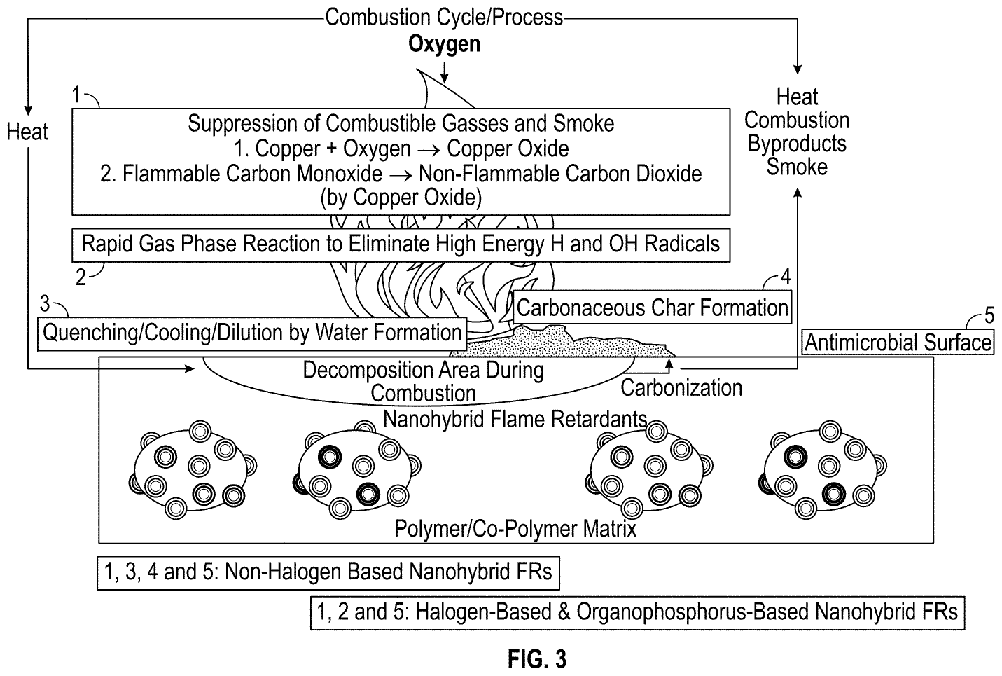

As referred to herein, temperature adaptive flame retardancy is the change of flame retardant reactive mechanisms as a function of environment temperature. The mechanism of flame retardance can be one or more combination of the following (as depicted in FIG. 3): vapor-phase inhibition, solid-phase char formation, and quenching/cooling behavior.

Vapor-phase inhibition during combustion means the flame retardant reacts with the burning polymers in vapor phase to produce free radicals that disrupt and stop the combustion process and is primarily related to halogenated flame retardant systems. Solid-phase char formation during combustion means the flame retardants react to form a carbonaceous layer on the surface and create a physical barrier that hinders the release of flammable gases to fuel combustion process. This mechanism is primarily related to non-halogen flame retardant systems. The quenching/cooling behavior is a mechanism related to hydrated materials belonging to the class of non-halogen flame retardants (for example, aluminum trihydrate, magnesium hydroxide, etc.). During consumption, such materials can undergo endothermic reactions to release water molecules, which cool and dilute the consumption process.

Combustion/fire is a chemical chain reaction and is categorized as a high-temperature exothermic (heat releasing) redox chemical reaction. Therefore, in all the above frame retardant mechanisms, temperature plays a critical role in activating and managing the flame retardant reactions. The ability of the nanohybrid in influencing the temperature-activated flame retardant mechanisms differentiate it from the prior arts. The nanohybrid consists of organic/inorganic halogenated and/or non-halogenated flame retardants that are surface modified with nanostructured copper and its oxides before being integrated to polymers. During the onset of fire or combustion, the increased presence (particle concentration) and distribution of thermally conductive copper nanoparticles causes localized heating/heat flux concentration within the flame retardant and polymer network. This localized heating/heat flux concentration allows for the following temperature adaptive flame retardant behavior: temperature lowering, acceleration of inhibition mechanisms, and accelerated random pyrolysis.

Lowering the reaction temperature of flame retardants occurs during combustion by initiating vapor-phase inhibition and/or solid-phase char formation and/or quenching/cooling reactions. This adaptive flame retardancy behavior causes lower than usual temperatures and shut down the combustion process early, well before maturing and spreading. Another adaptive flame retardancy behavior triggers the thermoreactive mechanisms of flame retardants during combustion to accelerate flame retardance rate (free radicle, char-formation, and water release) for shutting down the flames/fires. Finally, accelerated random pyrolysis and hence, melting of thermoplastic and thermosetting polymers for lower mass loss rates and reduced volatilization is another adaptive flame retardancy behavior. Many studies, including Zhang et al (included herein as reference) have reported reduced contribution in fire development from polymers that decomposes from random pyrolysis process.

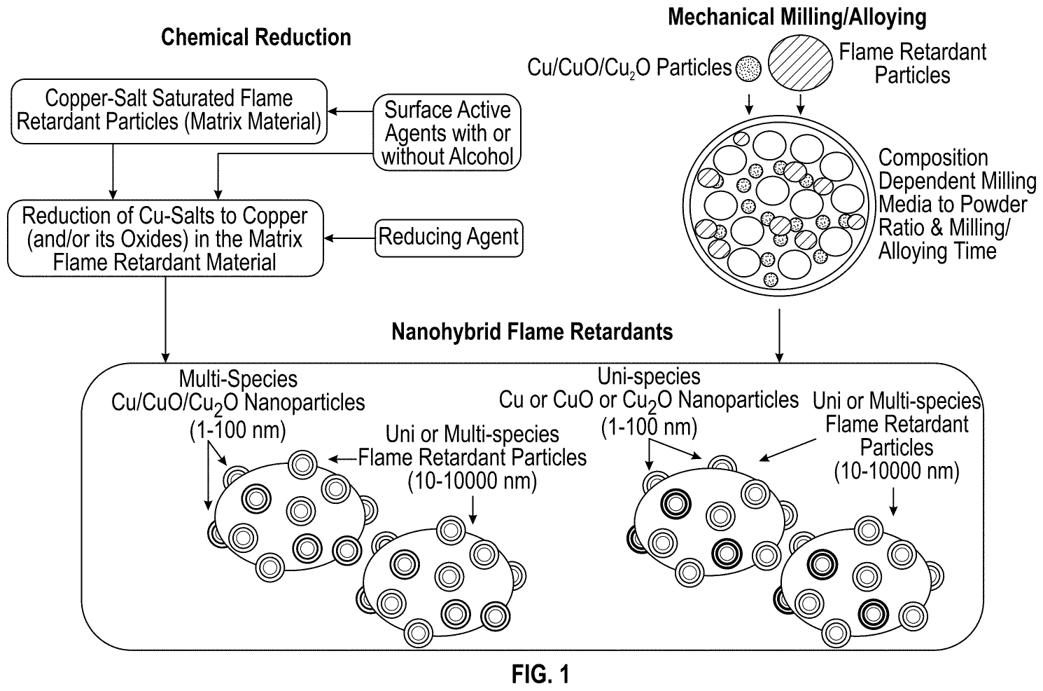

For example, a flow diagram of a chemical reduction reaction is provided in FIG. 1. As shown, flame retardant materials saturated with copper salts (including but not limited to copper chloride, copper sulfate, copper nitrate, and other water-soluble copper salts) are reduced to Cu/Cu₂O/CuO nanoparticles and then thermally cured to yield nanohybrid flame retardant composition. To control oxidized state of copper, the reduction reaction may include a combination of reducing agents with surface activating agents in aqueous media, either with or without short-chain organic alcohols. The reducing agent can be the compounds containing acidic or basic groups, or pH neutral groups. Examples of the reducing agents include citric acid, boric acid, hydrazine, butyl aldehyde, diethylene glycolmonobutyl ether, sodium boric acid, sodium citrate, ascorbic acidcetyltrimethyl ammonium bromide, ammonia, and hydroxyl benzaldehyde. Surface active agents can be any surfactant or dispersant containing cationic, anionic, non-ionic, and zwitterionic groups or the combination of any two of the functional groups in one molecule. Representative examples of such surface active agents include but are not limited to cyclodextrin, poly(vinyl pyrrolidone), poly(ethylene glycol), poly(vinyl alcohol), sodium dodecyl benzenesulfonate, abietic acid, polyehtoxylated octyl phenol, sorbitan monoester, glycerol diester, dodecyl betaine, N-dodecyl piridinium chloride, sulfosuccinate, 2-bis(ethyl-hexyl) sodium sulfosuccinate, alkyl dimethyl benzyl-ammonium chloride, cetyl trimethyl ammonium bromide, hexadecyl trimethyl ammonium bromide and similar molecules. Depending on the embodiment, the preferred surface active agents may be cyclodextrin, poly(ethylene glycol), poly(vinyl pyrrolidone), poly(vinyl alcohol), sorbitan momoester, glycol diester; and the most preferred are poly(ethylene glycol) and poly(vinyl pyrrolidone). Water and alcohol ratio is optional but in a preferred embodiment, would have not more than 70% alcohol in the aqueous mixture.

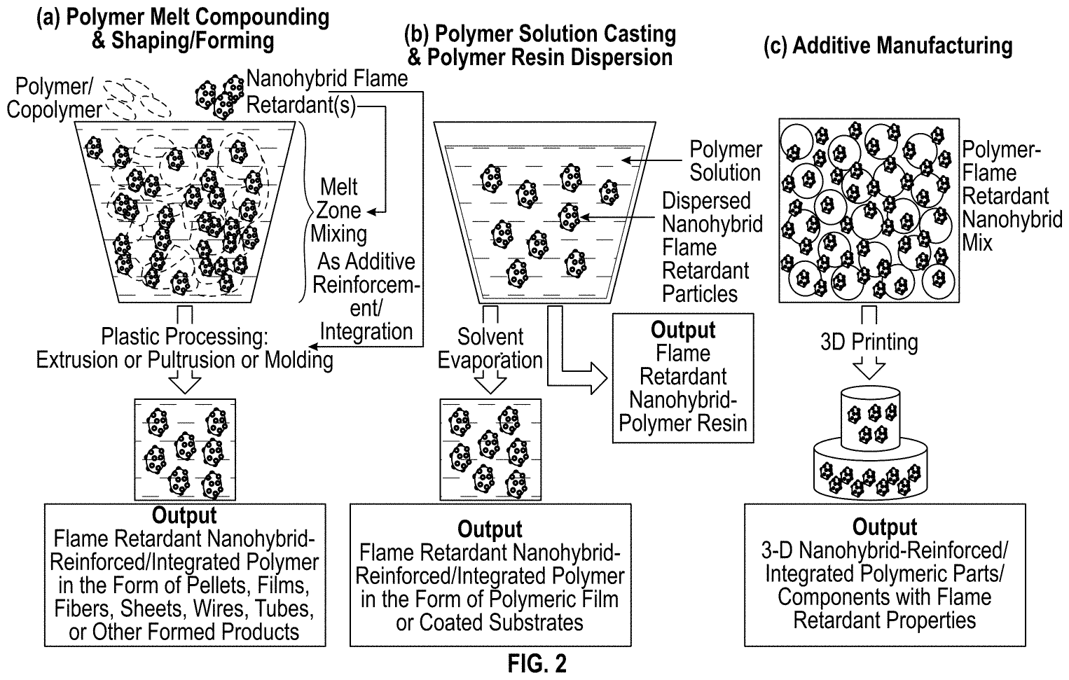

A simplified illustration of high-energy mechanical alloying is provided as FIG. 2. In this process, Cu/Cu₂O/CuO particles, flame retardant material (e.g. APP), and auxiliary additives are fed in appropriate size ratios and concentrations to a high-energy mill such as an attritor or ball mill loaded with milling media commonly in the form of ceramic or hardened steel balls. The expanded movement of media at high RPMs exerts various forces such as impact, rotational, shear, and tumbling leading to repeated fracturing, cold welding, amorphization, and rewelding of blended particles to yield a homogeneous compound from dissimilar materials (e.g. Cu/Cu₂O/CuO-APP nanohybrid) while at the same time, causing size reductions and shape modifications as a function of milling time and ratio of milling media to particles.

These methods may be used to create the polymers and polymer compositions also claimed in the instant disclosure, which are formed by incorporating and reinforcing polymers with the nanohybrid flame retardant compositions. These polymer compositions may be in solid, semi-solid, and liquid resinous form and have flame retardant and/or smoke suppressant property/activity. In one embodiment, the flame retardant polymer composition consists of 20 wt. % to 99 wt. % of a polymer/copolymer and 1 wt. % to 80 wt. % of nanohybrid(s), wherein polymer/copolymer materials can be selected from: (a) Thermoplastics—HDPE, LDPE, LLDPE, Polypropylene, polyethylene, Acrylic, Polyamide nylon (6, 66, 6/6-6, 6/9, 6/10, 6/12, 11 & 12), polycarbonate, polystyrene, ABS, PVC, Teflon, Polyester, and PAA; (b) Thermosetting—Epoxy, phenolic, vinyl ester, polyurethane, cyanate ester, poly ester, urea formaldehyde, and silicone; and/or (c) Biopolymers from isoprene polymers, natural polyphenolic polymers, cellulose/nano cellulose, melanin, and/or complex polymers of long-chain fatty acids.

The flame retardant polymer compositions are manufactured from thermoplastic polymers, thermosetting polymers, and/or biopolymers as continuous phase/matrix (in solid, semi-solid and/or liquid phase), and nanohybrid(s) as dispersed phase/reinforcement. FIG. 2 summarizes different processes capable of forming flame retardant polymers by incorporating and reinforcing polymer/co-polymer matrix with nanohybrid flame retardant compositions. Such polymers and their products (in solid, semi-solid, and/or liquid state) may possess one or more of the following properties: temperature adaptable flame retardant behavior, enhanced suppression of flammable gas and smoke, catalysis of charring or thermal oxidative promotion of charring through the oxides of metals, enhanced heat sink behavior, and/or antimicrobial behavior.

In terms of temperature adaptable flame retardant behavior, the heat flux concentrating effect of copper (and its oxides) yields a temperature-responsive mechanism for thermal dissociation of flame retardant materials for rapid and effective flame retardant activity either via gas phase reactions, solid phase carbonaceous char formation and/or quenching/cooling. The suppression of flammable gas and smoke during combustion is caused by: 1) consumption of oxygen by Cu or Zn to rapidly transform to the oxides of Cu or Zn by thermal oxidation at high temperatures and 2) oxidizing flammable carbon monoxide to non-flammable carbon dioxide from oxygen supplied by copper oxide (CuO and Cu₂O). Enhanced heat sink behavior is contributed by the high thermal conductivity or heat transfer capability of nanostructured copper (or its compounds)-modified nanohybrid materials (e.g. Cu-CNT, Cu-Graphene, Cu—SiC, etc.) and their polymer-matrix composites (e.g. Cu-Graphene/Polypropylene or Polyamide). Additionally, the antimicrobial property of nanohybrid reinforced/integrated polymers and their products is derived from biocidal activity of copper and its compounds against a wide range of bacteria, fungus, and viruses. Antimicrobial activity is claimed against microbes (including bacteria, fungus, and viruses) and/or to reduce/inhibit growth of pathogenic/infectious/contaminating microbes and their biofilms.

### Example 1: Cu-APP/SiO₂ Nanohybrid Flame Retardant and its Application in Polyurethane Flame Retardant Coating on Textiles

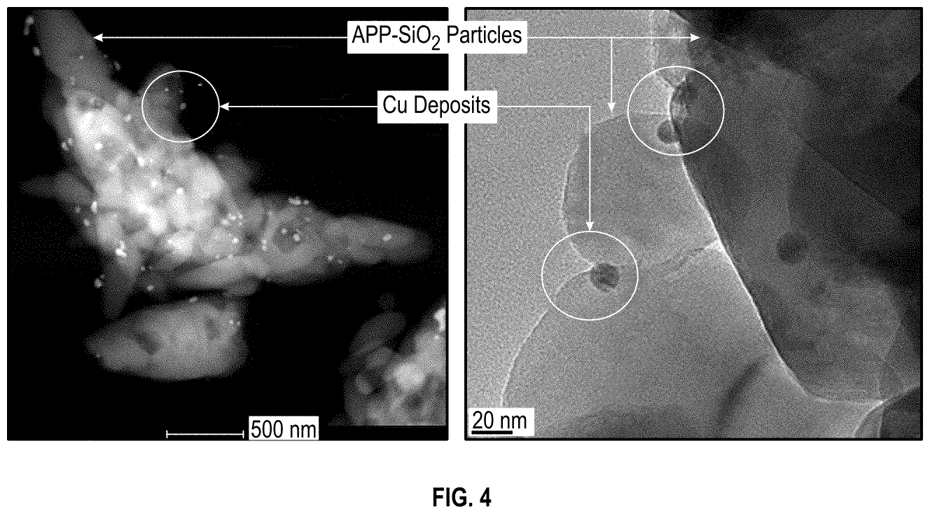

FIG. 4 shows a non-halogenated nanohybrid flame retardant composition formed by depositing copper nanoparticles (20 nm) on ammonium polyphosphate (APP) & silicon dioxide crystals (0.2 μm). In this composition, ammonium polyphosphate (APP) was selected as a non-halogen phosphorus-based flame retardant and silicon dioxide as a thermal insulator. APP act in both condensed phase and vapor phase as flame retardancy. In general, APP starts to decompose at temperatures >240° C. to act in condensed phase to form carbonaceous char layers to shield the underlying substrate from further exposure to oxygen and heat therefore preventing pyrolysis of the substrate. In the gas phase, APP reaction releases non-flammable CO₂ that dilutes flammable gases and combustion byproducts.

In this composition, the copper nanoparticles were derived by reducing copper chloride aqueous solution containing surfactant and alcohol. The process involved saturating the ammonium polyphosphate (APP) & silicon dioxide crystals with copper chloride (as metallic salt precursor) in an aqueous alcohol solution. The saturated aqueous mixture was then reacted with hydrazine monohydrate as reducing agent for reduction of copper chloride to copper (Cu) nanoparticles deposited in the matrix of ammonium polyphosphate (APP) & silicon dioxide. The output nanohybrid composition consisted of 1 wt. % of copper, 89 wt. % of ammonium polyphosphate (APP) and 10% of silicon dioxide.

Application of a thin film of polyurethane (PU) is very common in order to provide textiles with additional protection such as extremely strong water repellent/proofing characteristics and resistance against tears, abrasions, and kinks, etc. However, such PU coatings are highly combustible and decomposition from fire can form toxic by-products, such as carbon monoxide and hydrogen cyanide. To address flammability of such coatings, a flame retardant PU coating was prepared using the above described Cu-APP/SiO₂ composition. The coating formulation consisted of 15 wt. % of Cu-APP/SiO₂ composition in a functionalized aqueous suspension of polyurethane resin. Flame retardant coating was applied to polycotton textiles and thermally cured into a thin, flexible and well-adherent polyurethane-Cu-APP/SiO₂ nanohybrid structure. When the polyurethane-Cu-APP/SiO₂ are exposed to an accidental fire or heat, the inventive nanohybrid flame retardant triggers the decomposition of APP at temperatures much lower than 240° C. to initiate its condensed phase and vapor phase flame retardancy. As measured from thermogravimetric analysis, the initial decomposition temperature of polyurethane-Cu-APP/SiO₂ nanohybrid was reduced to 180° C. as compared to 250° C. for PU containing pure APP (without copper nanoparticles). This confirms the ability of the inventive nanohybrid composition in influencing the temperature-activated flame retardant mechanisms

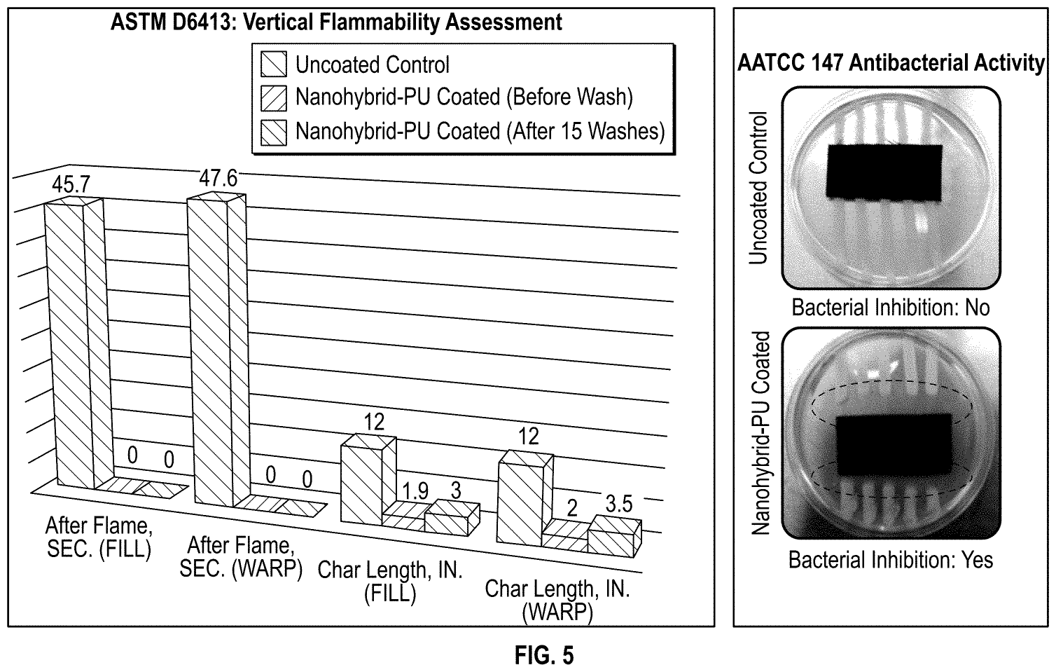

ASTM D6413 vertical flammability tests were performed on textile specimens with and without the polyurethane—Cu-APP/SiO₂ nanohybrid FR coating. As shown in FIG. 5, nanohybrid FR coated textiles demonstrated 0 seconds after flame duration once the flame source was removed and a char length of 1.9 inches. FR activity of the coated fabrics was maintained even after multiple laundry cycles, suggesting excellent wash durability of the nanohybrid FR technology. AATCC 147 antimicrobial assessment of the nanohybrid FR coated textile showed excellent bacterial inhibition (against S. epidermidis—a human flora bacterium) as compared to uncoated control specimen. These studies show excellent multifunctional potential of the nanohybrid flame retardant technology, especially for polymer systems requiring high surface activity and flame retardant performance.

To further test the antimicrobial efficacy of the nanohybrid compositions, a polyurethane nanohybrid (in the form of sealant foam) was manufactured by incorporating 5.5 wt. % Copper (Cu) deposited-SiO₂ structures. The effective concentration of Copper nanoparticles in the polyurethane nanohybrid was 0.08 wt. %. The antimicrobial testing of polyurethane-Cu—SiO₂ nanohybrid was tested as per JIS Z2801 standard against Staphylococcus aureus (gram positive bacteria) and Salmonella enterica (gram negative bacteria) microbial species. The antimicrobial efficacy tests results are listed in Table 1. As shown in Table 1, polyurethane-Cu—SiO₂ nanohybrid reduced the growth of Salmonella enterica by up to 90%, as compared to the control polyurethane foams. Against Staphylococcus aureus, polyurethane-Cu—SiO₂ nanohybrid showed a microbial reduction rate of 97% as compared to the control foams without the nanohybrid.

Similar antimicrobial tests were also performed on thermoplastic polymers using polyamide-Cu—SiO₂ based nanohybrid compositions. The nanohybrid compositions consisted of 0.075 wt. % of copper nanoparticles. To enhance the antimicrobial performance, an equivalent wt. % of silver nanoparticles was also incorporated in the nanohybrid compositions. The antimicrobial efficacy test results are summarized in Table 2. After 24 hours of contact time with microbes, the nanohybrid integrated polyamide composition showed 99.999% less colony forming units (CFUs) of Staphylococcus aureus (gram positive bacteria) as compared to control polyamide without the nanohybrid. Excellent antimicrobial performance of polyamide-based nanohybrid composition was also extended to Salmonella enterica (gram-negative bacteria) with 99.9999% less colony forming units (CFUs)) as compared to the control polyamide substrates.

### Example 2: Nanohybrid-Filled Polypropylene

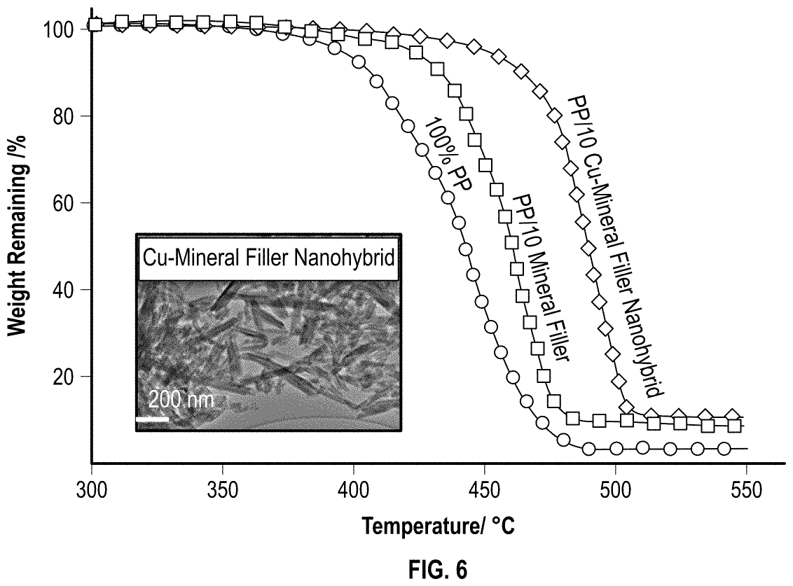

Thermal behavior of polypropylene filled with Cu-mineral filler (HNTs) based nanohybrid was studied using thermogravimetric analysis, as shown in FIG. 6. Cu-mineral filler nanohybrid consisted of 2 wt. % nanostructured Cu in a 98 wt. % matrix of mineral filler and was manufactured via chemical reduction. For this study, incorporation of mineral filler and Cu-mineral filler nanohybrid in polypropylene was accomplished during melt compounding. The thermal stability of PP was significantly improved by the incorporation of Cu-Mineral filler nanohybrid. As compared to 10 parts per hundred resin of pure mineral filler, Cu-mineral filler nanohybrid improved thermal stability of PP due to its enhanced heat barrier and stabilizing properties.

In another embodiment of disclosure, this invention relates to forming unique polymer nanohybrids by incorporating, bonding, and reinforcing organic polymers with above described organofunctionalized antimicrobial nanohybrids. The inventive polymer nanohybrids consist of an organic polymer and/or copolymer as continuous phase or matrix containing dis-continuous or dispersed phase of antimicrobial nanohybrid structures. Incorporation of antimicrobial nanohybrids (e.g. organofunctionalized Ag—ZnO nanohybrid) will impart antimicrobial characteristics to the polymer composition (e.g. polypropylene) and end-use products manufactured from such polymers (e.g. HEPA filter fibers) including woven/nonwoven fabrics. Therefore, the polymer nanohybrids are also referred as antimicrobial polymer nanohybrids. In addition to antimicrobial properties, the incorporation of antimicrobial nanohybrids structures may also strengthen/reinforce the polymer matrix by introducing unique properties, such as mechanical strength, toughness and electrical or thermal controlled properties. The inventive polymer nanohybrids can also be formed from both organofunctionalized antimicrobial nanohybrids and as well as from non-functionalized ones. Although, the former is preferred due to covalent bonding of organofunctional groups with organic polymer networks for enhanced organic-inorganic compatibility and antimicrobial activity.

In one embodiment, the antimicrobial polymer nanohybrids consists of 20 wt. % to 99 wt. % of an organic polymer/copolymer composition and 1 wt. % to 80 wt. % of antimicrobial nanohybrid(s), wherein organic polymer/copolymer materials can be selected from: (a) Thermoplastics—HDPE, LDPE, LLDPE, Polypropylene, Acrylic, Polyamide nylon (6, 66, 6/6-6, 6/9, 6/10, 6/12, 11 & 12), polycarbonate, polystyrene, ABS, PVC, Teflon, Polyester, and PAA; (b) Thermosetting—Epoxy, phenolic, vinyl ester, polyurethane, fluoropolymers, cyanate ester, poly ester, urea formaldehyde, and silicone/polysiloxane; and/or (c) Biopolymers derived from isoprene polymers, natural polyphenolic polymers, cellulose/nano cellulose, lignin, melanin, and/or complex polymers of long-chain fatty acids.

To accommodate different applications, the polymer nanohybrids can be manufactured from thermoplastic polymers, thermosetting polymers, and biopolymers as continuous phase or matrix, and the antimicrobial nanohybrid(s) incorporation/reinforcement process can be accomplished in solid, semi-solid, and liquid phase of matrix polymers. Various plastic/polymer processing techniques can used for manufacturing the inventive polymer nanohybrids with the antimicrobial nanohybrid structures depending on the quantity and production rate, dimensional accuracy and surface finish, form and detail of the product, nature of polymeric material and size of final product. The incorporation of the antimicrobial nanohybrids in polymers to form polymer nanohybrids can be accomplished by the following processing techniques as shown in FIG. 3: Polymer compounding or melt blending, shaping or forming, polymer solution casting, and additive manufacturing.

Polymer compounding or melt blending involves mixing and/or blending organic polymers/copolymer resins with antimicrobial nanohybrids and other additives/fillers relevant for the polymeric products such as coloring pigments, reinforcing materials, antioxidants, UV stabilizer, plasticizers, antistatic agents, etc. The compounded polymer-antimicrobial nanohybrid blend can be fed directly or can be converted into solid pellets, composite resins and blends before feeding to shaping/forming processes described below.

The compounded material mix can be processed through different industrially available shaping or forming techniques, including but not limited to Thermoforming, Compression and transfer molding, Rotational molding and sintering, Extrusion and extrusion-based processes, Injection molding, Blow molding and/or Plastic foam molding. All these processes utilize some kind of constraint followed by cooling/curing to form antimicrobial polymer nanohybrids in desired shape and size configurations (such as films, tubes, fibers, wires, bottles, sheets, and other configurations).

Polymer solution casting is a processing technique where the antimicrobial nanohybrid structures are thoroughly mixed and dispersed (using powder dispersion, solution mixing and/or wet milling/grinding procedures) in organic polymers dissolved or dispersed in a solution. The mixed solution is coated onto a carrier substrate, and then the water or solvent is removed by drying to create a solid layer on the substrate. The resulting cast layer can be left as an antimicrobial coating overlayer or can be stripped from the carrier substrate to produce a standalone antimicrobial nanohybrid film.

The manufacturing of the inventive antimicrobial polymer nanohybrids is extended to additive manufacturing (also known as 3D printing) techniques as well. In AM processes, a polymer composite or a powder bed consisting of well-homogenized antimicrobial nanohybrid structures in a polymer matrix is deposited layer upon layer into precise geometric shapes. Computer-aided-design (CAD) software or 3D object scanners directs the AM hardware that consists of a heat or high energy power source (e.g. laser, thermal print head) to consolidate material (nanohybrid-polymer mix or complex) through layering method to form 3D objects with antimicrobial properties.

The above processing techniques facilitates the dispersion and bonding of antimicrobial nanohybrid structures within the polymer matrix, including covalent bonding between organofunctional groups and organic polymer networks and forming/shaping polymeric parts/products with desired configuration and antimicrobial properties for industrial and consumer use. An example of covalent bonding between a thermoset urethane polymer and amino functionalized nanohybrid structure during polymer processing is given below.

For the purpose of understanding the Surface Activated Nanohybrid Flame Retardants and Polymers Produced Therefrom, references are made in the text to exemplary embodiments of a methods or processes of formation and compounds, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment. Furthermore, the described features, advantages, and characteristics may be combined in any suitable manner in one or more embodiments. One skilled in the relevant art will recognize that the Surface Activated Nanohybrid Flame Retardants and Polymers Produced Therefrom may be practiced without one or more of the specific features or advantages of a particular embodiment. In other instances, additional features and advantages may be recognized in certain embodiments that may not be present in all embodiments.

TABLE 1

| | | Contact | CFU/ | R | Percent |
|---|---|---|---|---|---|
| Microorganism | Sample | Time | Coupon | Value | Kill % |
| Salmonella | Control | 24 Hours | 2.45 + 06 | | |
| enterica | Sealant | | | | |
| | Foam | | | | |
| | Nanohybrid | 24 Hours | 2.50E+5 | 0.99 | 90% |
| | Sealant | | | | |
| | Foam | | | | |
| Staphylococcus | Control | 24 Hours | 4.55 + 06 | | |
| aureus | Sealant | | | | |
| | Foam | | | | |
| | Nanohybrid | 24 Hours | 1.27E+5 | 1.55 | 97% |
| | Sealant | | | | |
| | Foam | | | | |

TABLE 2

| | | | | % |
|---|---|---|---|---|
| | | | | Reduction |
| | | Contact | | in CFU as |
| | | Time | CFU/ | compared |
| Microorganism | Sample | (hr.) | Coupon | to control |
| Staphylococcus | Control Polyamide | 24 | 1.10E+06 | |
| aureus | (no nanohybrid) | | | |
| | Polyamide-Cu—SiO₂ | 24 | 1.00E+01 | 99.999% |
| | nanohybrid | | | |
| Salmonella | Control Polyamide | 24 | 2.52E+07 | |
| enterica | (no nanohybrid) | | | |
| | Polyamide-Cu—SiO₂ | 24 | 1.00E+01 | 99.9999% |
| | nanohybrid | | | |

1-17. (canceled)

18. A flame retardant polymer composition produced by the following steps:
a) producing a nanohybrid flame retardant composition; and
b) incorporating and reinforcing polymer or co-polymer matrix with nanohybrid flame retardant compositions;
wherein said nanohybrid flame retardant composition exhibits temperature adaptive flame-retardant behavior.

19. The flame retardant polymer composition of claim 1 wherein the polymers are selected from the group consisting of thermoplastic, thermosetting, and/or biopolymers category of polymers.

20. The flame retardant polymer composition of claim 1 wherein the polymers are selected from the group consisting of polypropylene, polyethylene, polyamide, PVC, polycarbonate, ABS and PBT.

21. The flame retardant polymer composition of claim 1 wherein the processes can be accomplished in solid, semi-solid, and liquid phases of matrix polymers.

22. The flame retardant polymer of claim 1 wherein the composition is a solid selected from the group comprising fibers, wires, tubes, pellets, bottles, woven/non-woven fabrics, films, coated substrates.

23. The flame retardant polymer of claim 1 wherein the composition is a liquid such as a polymer resin and coating formulation.

24. The nanohybrid polymer of claim 1 wherein the composition has an antimicrobial efficacy against gram-positive and gram-negative bacteria, fungi, and viruses that is greater than 90%.
